(19) United States
(12) Patent Application Publication
(10) Pub. No.: US 2008/0202825 A1
(43) Pub. Date: Aug. 28, 2008

(54) Smart electrical retrofit

(76) Inventor: Jack Kerish, Phoenix, AZ (US)

Correspondence Address: JACK KERISH, 2250 EAST WILLIAMS DR., PHOENIX, AZ, 85024, US

(21) Appl. No.: 11/458,281

(22) Filed: Feb. 27, 2007

(51) Int. Cl. B60K 16/00

(52) U.S. Cl. 180/2.2

(57) ABSTRACT

Smart Electrical Retrofit for existing and new gasoline vehicles is alternative electrical driving mode. The Retrofit creates Bi-Drive Vehicle from existing and new gasoline vehicles. The driver has a choice to drive the vehicle in present gasoline mode, and switch to a cheaper and pollution free electrical driving mode.

### FIELD OF THE INVENTION

The present invention relates to existing and new gasoline vehicles as alternative independent electrical drive mode.

### BACKGROUND OF THE INVENTION

Present Gasoline Engine driven vehicles use oil for energy source and produce pollution. Oil is in limited supply and the pollution is health and environmental hazard.

Most of the solutions are in the area of alternative energy sources, and most of the solutions are directed to improving the performance of the gasoline engine. Development to produce fuel from farm products has been going for quite some time. Use of natural gas to reduce pollution has been applied to Bi Fuel Vehicles (Dual tank Gasoline and Natural gas solution). Hybrid Vehicles is another solution, but still uses gasoline engine to generate electricity and latest development (Plug in Vehicle) is attempt to use electrical grid energy and store it in battery to extend the mileage range and reduce pollution and driving cost.

Electrical Vehicle approach is to reduce the pollution and driving cost, it is the only zero pollution solution. Electrical storage technology is a major obstacle to wide spread application. Present technology development makes possible the construction of Electrical Energy Storage Tank. Electrical motor technology is also advanced to create high power traction drive system.

Gasoline engine is a well developed technology, and oil is a high energy supply source with well established infrastructure. Increase demand on oil and finite supply creates price increase and politically hostile environment in addition to the pollution from its use. All other solutions need large capital investment and R&D breakthrough in technology to really compete with present gasoline engine and its energy source the oil.

Therefore, the main object of the invention is to reduce the cost of driving and have zero pollution operation by design. Large scale electrical storage from utility grid and renewable energy from sun and wind is another object of the invention. Electrical Energy Storage Tank and Electrical Traction Drive is to be created in direct competition with Gasoline Engine, Gasoline tank driving range and Mechanical Transmission, with technology advancement to match and exceed the performance of the gasoline engine and gasoline tank. Most important object is to create product that is easily incorporated into the existing and new gasoline vehicles.

### SUMMARY OF THE INVENTION

Electrical Retrofit for existing gasoline vehicles is alternative electrical driving mode. The driver has a choice of driving the vehicle in present gasoline mode if needs to, and switch to a cheaper and zero pollution electrical driving mode at any time.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a smart electrical retrofit;

FIG. 2 is a perspective view of an electrical energy storage tank designed to store electrical energy from utility grid, solar cells and wind powered generator;

FIG. 3 is a detail view of a traction wheel;

FIG. 4 is a front section view of a traction wheel cross section; and

FIG. 5 is a detail view of a computer.

For purposes of clarity and brevity, like elements and components will bear the same designations and numbering throughout the Figures.

### DESCRIPTION OF THE PREFERRED EMBODIMENT

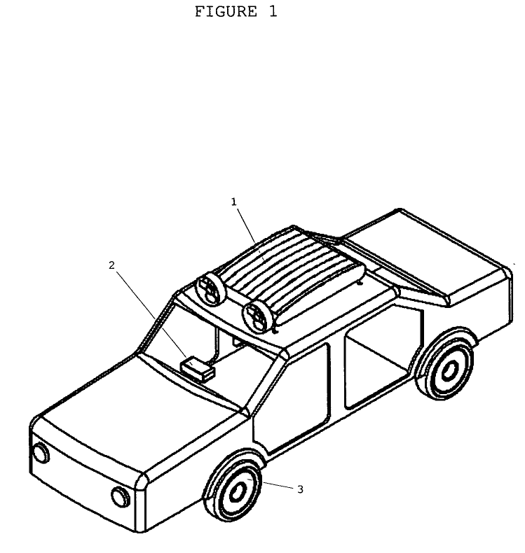

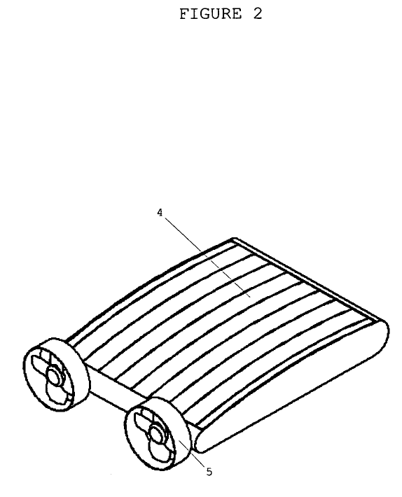

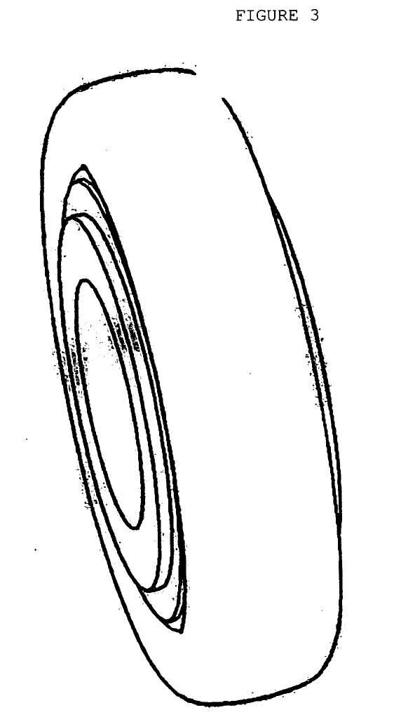

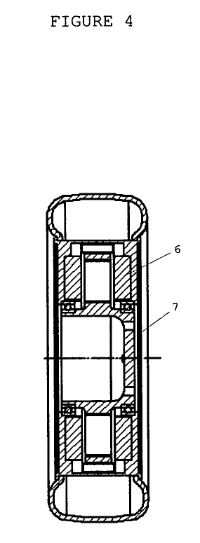

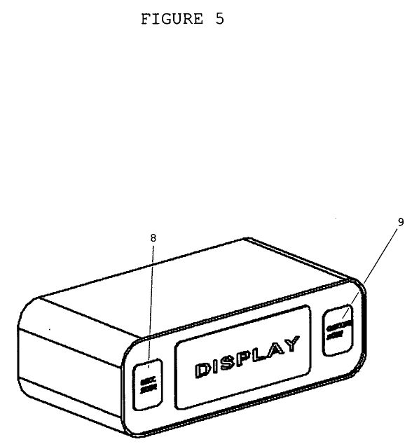

Smart Electrical Retrofit FIG. 1 is a perspective view of the product with its major components now referring to FIG. 2, FIG. 3, FIG. 4 and FIG. 5

Electrical Energy Storage Tank 1. is large scale electrical energy storage similar to existing gasoline tank, except stores electrical energy instead of gasoline. It is designed to store electrical energy from several sources with appropriate electronic control interface. EDLab is developing proprietary technology to construct the electrical storage tank and its description is not available at the time of this patent application. Meanwhile there is technology developed by several vendors that can be customized to fit Smart Electrical Retrofit product. Information and description of such technology can be obtained by contacting Toshiba Corporation fast charging lithium ion battery or Electrovaya Inc Toronto, Ontario for their Lithium Ion SuperPolymer battery for their technology.

Solar cell 4 element of Electrical Energy Storage Tank 1 is to utilize renewable electrical energy from the sun when available to supplement utility grid primary energy source used to charge the electrical storage tank. Solar cells are renewable energy part of the storage tank as energy generating on board device, and the technology is available from multiple vendors such as Pyron Solar, Inc. San Diego Calif. 92117 has high efficiency solar cells applicable to Electrical Retrofit. MIASOLE Santa Clara, Calif. 95051 also has applicable technology for constructing solar cells element.

Wind turbine electrical generator 5 element is renewable electrical energy source and is part of Electrical Energy Tank. It is onboard electrical energy producing device. Applicable technology has been developed by several vendor and can be customized to fit Electrical Energy Tank and it is available technology from vendors like Samrey-US A Division of Pine Ridge Products ILL

EDLab Ltd uses proprietary technology for Electrical Energy Storage Tank 1, solar cell 4, and Wind turbine electrical generator. The technology is under development at this time and will be covered by patents when applicable. The technology can be licensed when it is available.

Computer 2 provides control for the motorized wheels and energy storage tank. It is placed on the vehicle's dashboard and displays information such as energy level, driving speed, driving mode, and component temperature. Another main function is to switch the driving modes from gasoline to electrical and electrical to gasoline with the press of a button, which is located on the computers panel itself. Any industrial grade computers can be used for this application. Computers hardware and software are available from several industrial computers vendors such as ADEK Technical Sales, Inc. 8 Rebel Road Hudson, N.H. 03051.

Traction wheel 3 replaces present wheels with traction wheels. The wheels are specialized electrical motors with stationery part stator 7 and rotating part rotor 6. The wheels use mechanical transmission of the existing vehicle when it is driven in gasoline mode 9, or they become a traction drive by itself when driven in electrical mode 8. Technology for traction wheel is available from several suppliers such as Etel Inc. Schaumburg Ill., Bosch Rexroth Corp.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A smart electrical retrofit for existing and new gasoline driven vehicles, comprising:
means for to store electrical energy from utility grid or from photovoltaic cells and wind turbine;
means for vehicle propulsion;
means for to utilize the energy from the sun to generate renewable electrical energy, suitably connected to said means for to store electrical energy from utility grid or from photovoltaic cells and wind turbine;
means for to generate renewable electrical energy from wind, suitably connected to said means for to store electrical energy from utility grid or from photovoltaic cells and wind turbine;
means for stationary part of the traction wheel;
means for moving part of the traction wheel;
means for to switch back to gasoline drive mode;
means for to switch to electrical drive mode; and
means for system control and display of electrical energy level, vehicle speed, suitably connected to said means for vehicle propulsion, and suitably connected to said means for to store electrical energy from utility grid or from photovoltaic cells and wind turbine.

2. The smart electrical retrofit in accordance with claim 1, wherein said means for to store electrical energy from utility grid or from photovoltaic cells and wind turbine comprises an electrical energy storage tank.

3. The smart electrical retrofit in accordance with claim 1, wherein said means for vehicle propulsion comprises a rotor, stator traction wheel.

4. The smart electrical retrofit in accordance with claim 1, wherein said means for to utilize the energy from the sun to generate renewable electrical energy comprises a solar cell.

5. The smart electrical retrofit in accordance with claim 1, wherein said means for to generate renewable electrical energy from wind comprises a wind turbine electrical generator.

6. The smart electrical retrofit in accordance with claim 1, wherein said means for stationary part of the traction wheel comprises a stator.

7. The smart electrical retrofit in accordance with claim 1, wherein said means for moving part of the traction wheel comprises a rotor.

8. The smart electrical retrofit in accordance with claim 1, wherein said means for to switch back to gasoline drive mode comprises a gasoline mode.

9. The smart electrical retrofit in accordance with claim 1, wherein said means for to switch to electrical drive mode comprises an electrical mode.

10. The smart electrical retrofit in accordance with claim 1, wherein said means for system control and display of electrical energy level, vehicle speed comprises a computer.

11. A smart electrical retrofit for existing and new gasoline driven vehicles, comprising:
an electrical energy storage tank, for to store electrical energy from utility grid or from photovoltaic cells and wind turbine;
a rotor, stator traction wheel, for vehicle propulsion;
a solar cell, for to utilize the energy from the sun to generate renewable electrical energy, suitably connected to said electrical energy storage tank;
a wind turbine electrical generator, for to generate renewable electrical energy from wind, suitably connected to said electrical energy storage tank;
a stator, for stationary part of the traction wheel;
a rotor, for moving part of the traction wheel;
a gasoline mode, for to switch back to gasoline drive mode;
an electrical mode, for to switch to electrical drive mode; and
a computer, for system control and display of electrical energy level, vehicle speed, suitably connected to said traction wheel, and suitably connected to said electrical energy storage tank.

12. A smart electrical retrofit for existing and new gasoline driven vehicles, comprising:
an electrical energy storage tank, for to store electrical energy from utility grid or from photovoltaic cells and wind turbine;
a rotor, stator traction wheel, for vehicle propulsion;
a solar cell, for to utilize the energy from the sun to generate renewable electrical energy, suitably connected to said electrical energy storage tank;
a wind turbine electrical generator, for to generate renewable electrical energy from wind, suitably connected to said electrical energy storage tank;
a stator, for stationary part of the traction wheel;
a rotor, for moving part of the traction wheel;
a gasoline mode, for to switch back to gasoline drive mode;
an electrical mode, for to switch to electrical drive mode; and
a computer, for system control and display of electrical energy level, vehicle speed, suitably connected to said traction wheel, and suitably connected to said electrical energy storage tank.
